(19) United States
(12) Patent Application Publication
(10) Pub. No.: US 2008/0053769 A1
(43) Pub. Date: Mar. 6, 2008

(54) Friction Damper

(76) Inventor: Guy Valembois, Blagnac (FR)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/587,865

(22) PCT Filed: Apr. 22, 2005
(86) PCT No.: PCT/FR05/00999

§ 371 Date: Oct. 26, 2006

(30) Foreign Application Priority Data
Apr. 30, 2004 (FR) 0404637

(51) Int. Cl. F16F 7/09

(52) U.S. Cl. 188/381

(57) ABSTRACT

The invention relates to a friction damper comprising at least two guided relatively displaceable assemblies (100, 200), one of which is connected to a fixed reference and the other is movable, an intermediate member (300) which rests on the first assembly (100) and is relatively frictionally movable with respect thereto by an applied force and elastic means (400) acting upon said intermediate member. Said invention is characterised in that said elastic means (400) at standstill loads said intermediate member (300) resting on the first assembly (100) and the device also comprises control means (500) disposed between the intermediate member (300) and the second assembly (200) in such a way that the relative displacement between the two assemblies (100, 200) in a first relative displacement direction therebetween is braked by a friction force defined by the elastic means (400), while in the second relative displacement direction between the two assemblies (100, 200), while the control means (500) acts on the elastic means (400) in order to modify the force applied on the intermediate member (300), in the second relative displacement direction between the two assemblies (100, 200).

The present invention relates to the field of friction dampers.

More precisely, an object of the present invention is to improve the means described in document FR-A-2 697 881.

Said document describes a friction damper that uses:

friction as a physical energy-absorption phenomenon;

buckling as a controlled device for loading friction surfaces; and

a control device allowing loading of the device.

The device thus described in document FR-A-2 697 881 looks very promising.

However, it requires a relative displacement between the friction surfaces in order to allow implementation of the friction. The response curve of a device of this type consequently exhibits two-stage loading. It is illustrated in FIG. 1.

That figure represents, as “Phase 1”, an initial loading phase, during the abovementioned relative displacement, and as “Phase 2” the nominal functioning phase of the damper.

A person skilled in the art will understand that Phase 1, which corresponds to the initial travel necessary before any nominal functioning, delays the functioning of the damper.

Furthermore, the embodiments presented in document FR-A-2 697 881 use washers allowing buckling, which act between a shaft and a bore. These washers are notched by radial slots that open out alternately on their outer periphery and their inner periphery. They have a globally conical geometry when the damper is at rest. The initial geometry of this rest position conditions the proper functioning of the damper. It thus requires a very refined embodiment, which generates significant manufacturing costs.

An object of the present invention is to propose a novel concept of friction damper that enables these two problems to be overcome, i.e. one that makes it possible to prevent a damper response that is delayed by an initial loading travel and, furthermore, one that makes it possible to reduce the manufacturing cost as compared to the arrangements described in document FR-A-2 697 881.

This object is achieved within the context of the present invention by virtue of a friction damper that comprises:

at least two guided relatively displaceable assemblies, one connected to a fixed reference, the other movable,

an intermediate member bearing against the one first of the assemblies and relatively frictionally displaceable with respect to this first assembly through the effect of an applied force,

elastic means acting on the intermediate member, characterized in that

the elastic means, at rest, load said intermediate member bearing on the first assembly, and

in that the device also comprises control means arranged between the intermediate member and the second assembly such that in a first direction of relative displacement between the two assemblies the relative displacement between them is braked by a friction force defined by the elastic means, while in the second direction of relative displacement between the two assemblies the control means act on the elastic means in order to modify the force exerted on the intermediate member.

According to another advantageous characteristic of the present invention, the elastic means bear between two separate zones of the intermediate member.

Further characteristics, objects and advantages of the present invention will become apparent on reading the following detailed description, and with reference to the appended drawings, which are given by way of non-limiting examples, and in which:

FIG. 1 described above diagrammatically shows the response curve of a friction damper according to document FR-A-2 697 881;

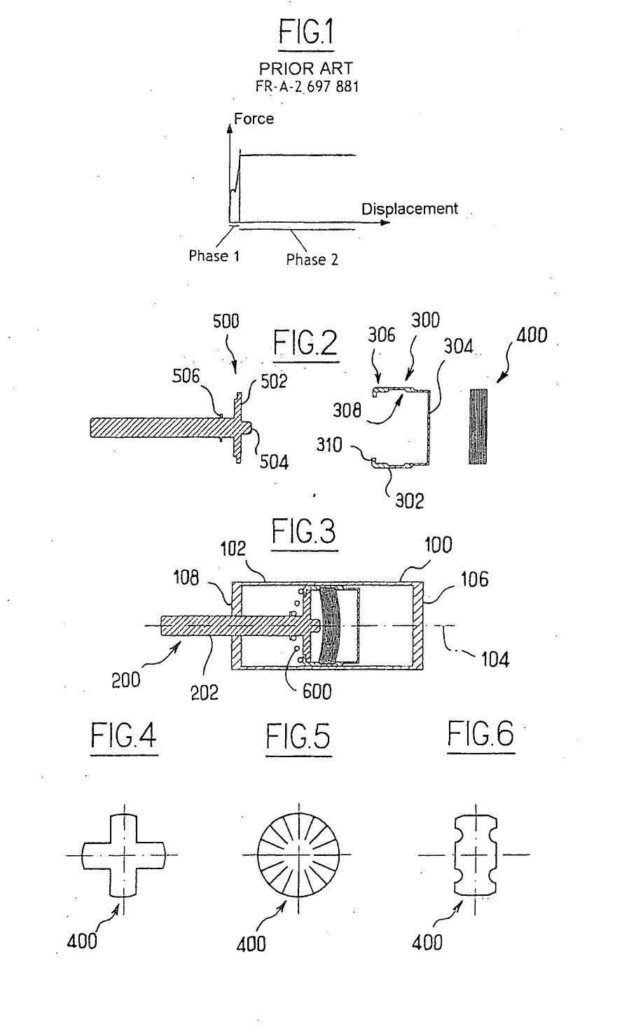

FIG. 2 shows an exploded view of the principal component parts of a damper according to the present invention;

FIG. 3 shows a view of the same damper according to the present invention, in the assembled position;

FIGS. 4, 5 and 6 show three variant embodiments of elastic means that can be used within the context of the present invention;

FIG. 7 shows the functioning of the damper according to the present invention, in one displacement direction;

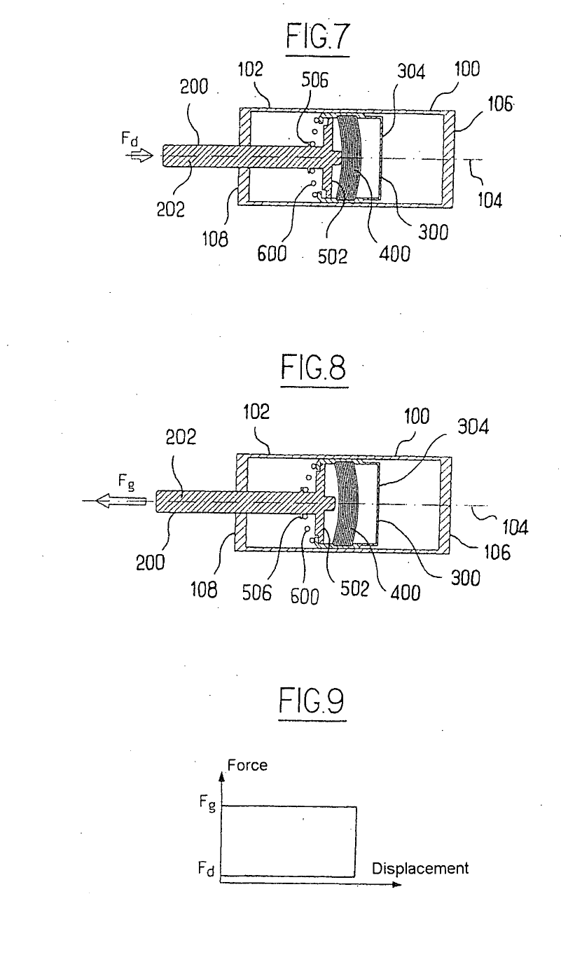

FIG. 8 shows the functioning of the same damper according to the present invention, in the opposite displacement direction; and

FIG. 9 shows the response curve obtained with a damper according to the present invention.

The appended FIGS. 2 and 3 show a friction damper according to the present invention.

These figures show two assemblies 100, 200 capable of relative displacement, an intermediate member 300, elastic means 400 and control means 500.

One of the two assemblies 100, 200, which are capable of relative displacement and are guided, is connected to a fixed reference and the other is movable. Arbitrarily, with reference to the appended FIGS. 2 and 3, the assembly 100 may be considered to be connected to the fixed reference and the assembly 200 to be movable relative to the first-mentioned assembly 100. However, this arrangement is not mandatory and, as appropriate, it is possible to envisage the assembly 200 being that which is connected to the fixed reference and the assembly 100 being the movable assembly.

Moreover, the concrete embodiment of the two assemblies 100, 200 may be the subject of a very large number of variant embodiments. That illustrated in the appended figures should in no way be considered as limiting.

According to the particular embodiment illustrated in the appended figures, the assembly 100 is formed from a tubular element 102, for example an element that is symmetrical in revolution about an axis 104. More specifically still, according to the representation given in FIG. 3, the tubular element 102 is closed off at one end by a partition 106. In a variant embodiment, however, this partition may be omitted. Furthermore, according to the representation given in FIG. 3, the tubular element 102 is provided, on its second axial end, with a second transverse partition 108 that has a central through-passage.

According to the representation given in FIGS. 2 and 3, the second assembly is formed from a rectilinear rod 202 that passes through the passage in the abovementioned partition 108 and is thus slidably guided relative to the assembly 102 along the axis 104.

The intermediate member 300 is designed in order to bear against the assembly 100. It is capable of relative displacement with regard to the latter, with friction, through the effect of a force applied by the elastic means 400.

The intermediate member 300 may also be the subject of a number of variant embodiments.

According to the particular, non-limiting embodiment given in the appended FIGS. 2 and 3, this intermediate member 300 comprises a tubular sleeve 302 arranged on the inside of the tubular element 102. The dimension of the outside cross section of the intermediate member 300 globally complements the dimension of the inside cross section of the tubular element 102. It will be noted that the latter preferably has a constant cross section over its entire length.

The tubular sleeve 302 is preferably provided, on one of these axial ends (facing the abovementioned partition 106), with a partition 304 transverse to the axis 104.

Preferably, the tubular sleeve 302 is produced from a material that allows a radial extension through the effect of the loading of the elastic means 400 in order to press the intermediate member 300 against the inner periphery of the tubular element 102. In a variant embodiment, the tubular sleeve 302 joined to the partition 304 may be provided with a plurality of cutouts or axial slots, i.e. parallel to the axis 104 allowing the abovementioned deformation, bearing against the inner surface of the tubular element 102 through the effect of the loading of the elastic means 400.

More precisely still, it will be noted, when examining the appended FIGS. 2 and 3, that the tubular sleeve 302 is preferably provided on its outer surface, over part of its length, with an extra thickness 306 that forms a deformable zone bearing, by friction, between the inner surface of the tubular element 102.

Moreover, preferably, the intermediate member 300 is provided with means that make it possible to contain the elastic loading means 400, which constitute a device for loading by means of buckling.

Preferably, these means for confining the elastic means 400 are formed from an annular groove 308 provided on the inner periphery of the tubular sleeve 302.

Lastly, preferably, the intermediate member 300 is also provided with means 310 that make it possible to limit the relative displacement between the intermediate member 300 and the control means 500 associated with the assembly 200.

According to the particular, non-limiting embodiment shown in the appended FIGS. 2 and 3, these latter means are formed from an annular rib 310 projecting from the inner surface of the tubular sleeve 302 at its opening contour opposite the partition 304.

The control means 500 are arranged between the intermediate member 300 and the second assembly 200. They are designed such that, in a first direction of relative displacement between the two assemblies 100 and 200, the relative displacement between them is braked by a friction force defined by the elastic means 400, while in the second direction of relative displacement between the two assemblies 100 and 200 the control means 500 act on the elastic means 400 in order to modify the force exerted on the intermediate member 300.

More precisely still, preferably, the control means 500 are formed from a plate 502 transverse to the axis 104, integral with an axial end of the rod forming the second assembly 200. The plate 502 has an external diameter that is at least slightly smaller than the inside cross section of the tubular sleeve 302 but slightly larger than the internal diameter of the rib 310.

A person skilled in the art will understand that, thus, when the plate 502 is engaged in the tubular sleeve 302, the plate 502 limits the relative displacement between the assembly 200 and the intermediate member 300 when it abuts against the rib 310.

It will be noted that, according to the embodiment shown in FIGS. 2 and 3, the control means 500 also comprise a finger 504 to the extension extending beyond the plate 502, axially, along the axis 104, toward the elastic means 400. This finger 504 is capable of loading the means 400 when the assembly 200 is displaced toward the right according to the representation of FIGS. 2 and 3 in order to modify the force exerted by the elastic means 400 on the intermediate member 300, after cancellation of the play that exists initially.

The elastic means 400 allow loading of the contact surfaces 302/102. These elastic means 400 may be the subject of a number of variant embodiments. They may consist of a multitude of washers of varied shapes, as illustrated in FIGS. 4 to 6, in order to allow buckling of shafts during assembly.

FIG. 4 shows an embodiment of elastic washers in the form of a four-branch cross.

FIG. 5 shows an embodiment of circular geometry elastic washers that comprise a plurality of radial slots opening out on the outer periphery.

FIG. 6 shows a variant embodiment of elastic washers formed from globally rectilinear strips punched on their lateral edges.

Of course, the elastic means 400 may also comply with the arrangements described in document FR-A-2697881. That is to say, use may be made of washers of circular geometry that are notched by radial slots that open out alternately on their outer periphery and their inner periphery.

Furthermore, as may be seen in FIGS. 2 and 3, the device according to the present invention is preferably supplemented by a return spring 600 that, at rest, loads the plate 502, bearing against the rib 310. According to the particular embodiment given in FIGS. 2 and 3, this return spring 600 is a flat-coil spring interposed between the axially outer surface of the rib 310 and a rib 506 provided on the rod 202, on that side of the plate 502 that is opposite the finger 504.

The functioning of the device thus formed can now be described with reference to FIGS. 7 and 8.

FIG. 7 gives a diagrammatic representation of the functioning of the device when the second assembly 200 is displaced toward the right relative to the first assembly 100.

Conversely, FIG. 8 gives a diagrammatic representation of the devices when the second assembly 200 is displaced toward the left relative to the first assembly 100.

A person skilled in the art will understand that, when the second assembly 200 is displaced toward the right relative to the first assembly 100, the play that initially exists between the finger 504 and the elastic means 400 is cancelled out. The finger 504 consequently loads the elastic means 400, deforms, and converts buckling into flexure, and thus significantly reduces the application of pressure of the surfaces 302/102. The flexure force is thus limited and the displacement of the assembly 200 facilitated.

Conversely, when, as illustrated in FIG. 8, the second assembly 200 is drawn toward the left relative to the first assembly 100, the abutment of the plate 502 on the rib 310 maintains the play that exists between the finger 504 and the elastic means 400. The intermediate member 300 is then loaded by the elastic means 400, which maintain the application of pressure of the tubular sleeve 302 against the inner surface of the tubular element 102. The displacement of the second assembly 200 is then accompanied by a frictional braking force. When the assembly 200 is no longer being displaced toward the left, according to FIG. 7, the spring 600 returns the system to the initial position.

The resulting force curve is illustrated in FIG. 9.

A person skilled in the art will understand that, as compared to the curve illustrated in FIG. 1 according to the prior art, the present invention makes it possible to dispense with any initial loading phase that is likely to delay braking of displacement.

Of course, the present invention is not limited to the embodiments described above, but encompasses all variant embodiments in accordance with its spirit.

In particular, it is possible to envisage any variant embodiment for the geometry of the pieces defined above. As appropriate, it is also possible to envisage providing a system for the multiplication of forces between the finger 504 and the elastic means 400, in order to reduce the return force.

The device according to the invention may give rise to numerous applications, for example the damping of the recoil of a firearm.

1. A friction damper comprising at least two guided relatively displaceable assemblies (100, 200), one connected to a fixed reference, the other movable,
an intermediate member (300) bearing against the one first (100) of the assemblies and relatively frictionally displaceable with respect to this first assembly through the effect of an applied force,
elastic means (400) acting on the intermediate member,
characterized in that the elastic means (400), at rest, load said intermediate member (300) bearing on the first assembly (100) and in that the device also comprises control means (500) arranged between the intermediate member (300) and the second assembly (200) such that in a first direction of relative displacement between the two assemblies (100, 200) the relative displacement between them is braked by a friction force defined by the elastic means (400), while in the second direction of relative displacement between the two assemblies (100, 200) the control means (500) act on the elastic means (400) in order to modify the force exerted on the intermediate member (300).

2. The device as claimed in claim 1, characterized in that the elastic means (400) bear against two separate zones of the intermediate member.

3. The device as claimed in claim 1, characterized in that the first assembly (100) comprises a tubular element (102) and the intermediate member (300) comprises a tubular sleeve (302) arranged inside the tubular element (102).

4. The device as claimed in claim 3, characterized in that the tubular element (102) has a constant cross section over the entire length of its inner surface.

5. The device as claimed in claim 1, characterized in that the intermediate member (300) is capable of deformation, for example of radial extension, through the effect of the loading of the elastic means (400).

6. The device as claimed in claim 1, characterized in that the intermediate member (300) comprises a tubular sleeve (302) provided with cutouts or slots suitable for allowing its expansion.

7. The device as claimed in claim 1, characterized in that the intermediate member (300) comprises a tubular sleeve (302) provided with an extra thickness (306) located on its outer surface and resting against the inner surface of the first assembly (100).

8. The device as claimed in claim 1, characterized in that the intermediate member (300) comprises means capable of containing the elastic loading means (400).

9. The device as claimed in claim 1, characterized in that the intermediate member (300) includes a groove (308) capable of confining the elastic loading means (400).

10. The device as claimed in claim 1, characterized in that the intermediate member (300) comprises means (310) capable of limiting the relative displacement between the intermediate member (300) and the control means (500).

11. The device as claimed in claim 1, characterized in that the control means (500) comprise a finger (504) carried by a plate (502) integral with the second assembly (200).

12. The device as claimed in claim 1, characterized in that the elastic means (400) comprise a multitude of washers.

13. The device as claimed in claim 1, characterized in that the elastic means (400) comprise means working in buckling.

14. The device as claimed in claim 1, characterized in that the elastic means (400) comprise cross-form elastic washers.

15. The device as claimed in claim 1, characterized in that the elastic means (400) comprise circular washers that include radial slots.

16. The device as claimed in claim 1, characterized in that the elastic means (400) comprise globally rectilinear strips punched on their lateral edges.

17. The device as claimed in claim 1, characterized in that it comprises return means (600).

18. The device as claimed in claim 17, characterized in that the return means (600) load an element (502) of the control means (500) against an element (310) of the intermediate member (300).

19. The device as claimed in claim 1, characterized in that it comprises a force-multiplication system associated with the control means (500).
